(19) United States
(12) Patent Application Publication
(10) Pub. No.: US 2018/0192629 A1
(43) Pub. Date: Jul. 12, 2018

(54) Fishing Rod Protective Harness

(71) Applicant: David Arnold, Baltimore, MD (US)

(72) Inventor: David Arnold, Baltimore, MD (US)

(21) Appl. No.: 15/863,855

(22) Filed: Jan. 5, 2018

Related U.S. Application Data
(60) Provisional application No. 62/443,000, filed on Jan. 6, 2017.

(51) Int. Cl. A01K 97/08

(52) U.S. Cl. CPC A01K 97/08

(57) ABSTRACT

A protective harness for a fully-rigged fishing rod during transport and/or storage, comprised of two hollow tubes that are closed at one end and open on the other end. The tubes are connected by an elastic cord attached near the open end of each tube. One tube slides over the upper (tip) portion of the rod, and the other tube slides over the lower (handle) portion of the rod, with the elastic cord stretching between the two tubes and maintaining tension, thus creating a protective harness that adheres to the fishing rod. This easy-on easy-off protective harness may be used on a one-piece or a multiple-piece fishing rod while it is fully rigged with tackle, acting as a lure guard as well as a rod protector. The tubes may be transparent to maximize viewing of the contents. When not in use, the tubes nest inside one another for convenient storage.

### BACKGROUND OF THE INVENTION

### 1. Field of the Invention

This invention relates to an improved fishing rod protector and lure guard that attaches to, rather than envelops, a fully rigged fishing rod during transport and/or storage. Further, the invention is easy to install and remove, allows for viewing of the contents within the encasement, allows for multiple encased rods to be easily carried in one hand, and then nests together during non-use for convenient storage.

### 2. Prior Art

In order to safely transport a fishing rod and avoid damage, line tangles, and/or hook snags, typically the user must endure the cumbersome process of removing the tackle and reel, and then inserting the rod an elongated encasement. Other encasements that do allow for a fishing rod to be protected without removing the reel and tackle are typically bulky, awkward to handle, and cumbersome to apply/remove. There are no fishing rod protective devices like this invention that can do the following: may be applied without removing reel and tackle, protects the rod tip and guides, guards the lure hooks from snagging objects, allows the contents to be viewed without removing the encasement, is quick and easy to apply or remove, is easy to carry one or multiple units in one hand, and conveniently nests together to save space during non-use.

Dewin B. Turners U.S. Pat. No. 1,903,798 issued April, 1933, called “Carrier Case” is a long tube designed to encase the entire fishing rod, restricts contents from view, and is bulky.

Theodore L. Smiths U.S. Pat. No. 2,143,720 issued January, 1939, called “Rod Case” is a long collapsible rod case tube designed to encase the entire fishing rod, restricts contents from view, is bulky, and requires the reel/tackle to be removed.

John H. Fishers U.S. Pat. No. 2,149,087 issued February, 1939, called “Protective Rod and Reel Case” encases the entire rod with a compartment for a fishing reel, restricts contents from view, and is bulky.

Gordon N. Tuttons U.S. Pat. No. 2,473,977 issued June, 1949, called “Enclosing Case for Fishing Rods and the Like” encases the entire rod, restricts contents from view, and is bulky.

Paul A. Flemings U.S. Pat. No. 250,270 Issued March, 1950, called “Fish and Gun box” encases the entire rod, restricts contents from view, and is bulky.

William R. Chalkers U.S. Pat. No. 2,591,674, issued April, 1952, called “Fishing Rod Carrying Case” encases the entire rod, restricts contents from view, and is bulky.

Jerome G. Daviau U.S. Pat. No. 2,595,230, issued May, 1952, called “Fishing Rod Case” attaches the fishing rod by means of clips, is time consuming to install, restricts contents from view, and is bulky.

Everett C. Surings U.S. Pat. No. 2,650,449, issued September, 1953, called “Fly Rod and Reel Case” is designed primarily for just a fly rod and reel, encases the entire fishing rod, the rod is attached by clips, and is bulky.

Boyd W. McKerns U.S. Pat. No. 2,749,645, issued June, 1956, called “Fishing Gear Container” encases the fishing rod by means of utilizing interconnected coplanar parallel telescoping tubes.

John L Kleckleys U.S. Pat. No. 2,854,775, issued October, 1958, called “Fishing Rod Case” encases the fishing rod or rods by means of parallel pockets, requires the fishing reel to be removed, and restricts from view the contents.

Jack E. Duffs U.S. Pat. No. 2,855,223, issued May, 1959, called “Telescopic Tube Coupling With Step Adjustment Means” encases its contents, restricts from view its contents and utilizes telescoping elongated members.

Clarence W. Harveys U.S. Pat. No. 2,902,790, issued September, 1959, called “Rod and Reel Case” encases the entire fishing rod and reel by means of an elongated rod receiver section having a plurality of parallel rod section recesses, restricts from view is contents, and is bulky.

Franklin H. Webers U.S. Pat. No. 2,919,017, issued December, 1959, called “Telescopic Carrying Case” encases its contents, utilizes telescoping tubes, restricts from view its contents and is bulky.

Lowell H. Morriss U.S. Pat. No. 2,962,187, issued November, 1960, called “Article Carrying Case” is a rigid elongated tube that encases, restricts from view its contents and is bulky.

Gerald W. Gottulas U.S. Pat. No. 3,131,503, issued May, 1964, called “Fishing Rod Protector” utilizes telescoping tubes to protect the fishing rod and an elastic bands and hooks tensioned against the fishing reel, requiring that their be a fishing reel attached. When not in use the elastic bands and hooks are exposed.

Claude J. Walkers U.S. Pat. No. 3,349,512, issued October, 1967, called “Interchangeable Rod and Reel Carder Apparatus” encases the entire fishing rod and reel, restricts from view contents, and is bulky.

Herbert J. Slades U.S. Pat. No. 3,399,009, issued August, 1968, called “Rod Case” is formed from conventional extruded metal or plastic strips providing a frame and sheet-like panels anchored to the frame or from a second embodiment the case is in the form of ne end opening sleeve which receives a tray carrying the rods.

Charles M. Marshall et al U.S. Pat. No. 3,356,246, issued December, 1967, called “Telescoping Rod Case with Sliding Cam Lock” encases the fishing rod or rods in a telescoping tubes, restricts from view the contents, and is bulky.

Toney Harrisons U.S. Pat. No. 3,575,327, issued April, 1971, called “Fishing Rod Carrying Cases” is essentially a sheet of flexible material with pockets, requiring the fishing reel to be removed, and conceals from view the contents.

Marshall R. Edwards U.S. Pat. No. 3,618,253, issued November, 1971, called “Fishing Apparatus” utilizes telescoping tubular sections, requires the fishing reel to be attached.

Gordon T. De Bakers U.S. Pat. No. 3,624,948, issued December, 1971 called “Fishing Rod and Reel Case” utilizes a tubular case that is attached to a fishing rod and reel by means of a tensioned elastic band, thereby requiring a fishing reel to be installed, when removed leaves the elastic band externally exposed and is bulky.

Heidtman et al U.S. Pat. No. 3,641,697, issued February, 1972, called “Carrying Case for a Fishing Rod and Reel” encases the entire fishing rod and reel in a rigid plastic hinged carrying case that restricts from view its contents and is bulky.

George R. Wrights U.S. Pat. No. 3,674,190, issued July, 1972, called “Carder for Rods with Reels Attached” is for at least two rods with reels attached, encases the entire fishing rod from view and is bulky.

Waldo O. Ratzlaffs U.S. Pat. No. 3,772,819, issued November, 1973, called “Carrying Case for Fishing Rods and Reels” utilizes a long tubular design to encase a plurality of rods and is bulky.

Sauey et al U.S. Pat. No. 3,811,216, issued May, 1974, called “Adjustable Fishing Rod Case” utilizes telescopic tubes to encase a plurality of fishing rods and is bulky.

Francis E. Geislers U.S. Pat. No. 3,972,144, issued August, 1976, called “Fishing Rod and Reel Case” utilizes an essentially rectangular shape with elongated compartments running parallel to its length to encase more than one fishing rod with or with reel.

Charles J. Wycoskys U.S. Pat. No. 4,136,478, issued January, 1979, called “Fishing Pole and Reel Holding Bag” utilizes a bag to encase a single fishing rod and reel.

Milton K. Wards U.S. Pat. No. 4,170,801, issued October, 1979, called “Fishing Rod and Reel Box” encases a plurality of fishing rods and reels, restricts from view the contents and is bulky.

Hoffman et al U.S. Pat. No. 4,171,588, issued October, 1979, called “Plastic Carrying Case for a Fishing Rod and Reel” encases the entire fishing rod and reel, restricts from view what is contained and is bulky.

Ronald A. Becks U.S. Pat. No. 4,222,193, issued September, 1980, called “Fishing Rod Case” is specifically for a fishing rod only, encasing the entire fishing rod in a braided plastic filament.

Jack L. Evans U.S. Pat. No. 4,546,877, issued October, 1985, called “Fishing Rod and Reel Cover” encases the entire fishing rod and reel, restricts from view what is contained within and is bulky.

Douglas M. Rays U.S. Pat. No. 4,641,454, issued February, 1987, called “Protective Sock for a rod and Reel” utilizes a protective sock to enclose a fishing rod and reel.

McBride et al U.S. Pat. No. 4,726,141, issued February, 1988, called “Fishing Rod and Reel Carrying Case” can carry more than one fishing rod with reel attached, encases only the fishing handle area with reel attached.

Homer L. Crafts U.S. Pat. No. 4,967,504, issued November, 1990, called “Fishing Rod and Reel Protector” encases the fishing rod in a elongated tube and expanded hollow area for fishing reel requiring a fishing reel, and is bulky.

Smith et al U.S. Pat. No. 5,046,279, issued September, 1991, called “Carrying Case for Fishing Rod and Reel” encases the entire fishing rod and reel, restricting from view what fishing rod is contained within, and is bulky.

Vonley D. Vances U.S. Pat. No. 5,319,874, issued June, 1994, called “Rod and Reel Case” encloses the entire fishing rod and reel, restricts from view what fishing rod is contained within, and is bulky.

Lannan et al U.S. Pat. No. 5,327,669, issued July, 1994, called “Rod Organizer” can contain a plurality of fishing rod and reels and is primarily a rectangular shaped fabric with multiple pouches encasing the entire fishing rod and reel.

Hepworth et al U.S. Pat. No. 5,341,590, issued August, 1994, called “Carrying Case for Fly Fishing Rod and Reel” encases the fishing rod and reel entirely and is bulky.

Matthew A. Millers U.S. Pat. No. 5,425,194, issued June, 1995, called “Fishing Rod Case” encases the fishing rod entirely in a hollow cylindrical tube, restricts from view the contents and is bulky.

Robert Glenn Wambolt U.S. Pat. No. 5,640,795, issued June, 1997, called “Rod guard-fishing rod protection system” is designed for two-piece rods, is overly complicated with multiple holes and bolts involved for rod centering, has 2 elastic cords running the entire length of the rod which are susceptible to hook snags, and is not an effective lure guard.

Michael T. Reichert U.S. Pat. No. 7,383,658, issued June, 2008, called “Fishing rod and reel protection systems” encases the entire rod, restricts contents from view, and is somewhat cumbersome to install/remove.

Christopher W. Scott U.S. Pat. No. D588,360, issued March, 2009, called “Fishing rod case” has a single tube with a cap that envelops the entire rod, restricts from view the contents, and is cumbersome to handle and/or store.

Eric M. Bates U.S. Pat. No. 8,650,796, issued February, 2014, called “Device for protecting a Fishing Rod” has a single collapsible hollow tube with connecting strap, cannot be used on a fishing rod with no reel, is susceptible to hook snags on tube joints during application/removal, has no lower tube making device more cumbersome to apply/remove as well making it impractical to use on multi-piece fishing rods.

Whatever the precise merits, features and advantages of the above cited references, none of them achieves or fulfills the purpose of protecting/guarding a fully rigged fishing rod like the present invention.

### SUMMARY OF THE INVENTION

Disclosed is a unique encasement for the transport and/or storage of a fully rigged fishing rod. The invention is comprised of two hollow tubes (“tube” meaning an elongated member that may be cylindrical, tapered, square, etc.) that are closed at one end and open on the other end. The tubes are connected by an elastic cord attached near the open end of each tube. One tube slides over the upper (tip) portion of the rod, and the other tube slides over the bottom (handle) portion of the rod, with the elastic cord stretching and maintaining tension to hold everything together, thus creating a protective harness that adheres to the fishing rod. This easy-on easy-off protective harness may be used on a one-piece or a multiple-piece fishing rod while it is fully rigged with tackle, acting as a lure guard as well as a rod protector. While the protective harness is in use, the tubes are separated by a gap, allowing viewing of the rod, reel, and line. The tubes may also be transparent for maximum viewing of the contents.

When not in use, the tubes nest inside one another for convenient storage.

### OBJECTS OF THE INVENTION

AN OBJECT of the present invention is to provide a device for protecting a fishing rod that avoids the disadvantages of the prior art.

ANOTHER OBJECT of the present invention is to provide a device for protecting a fishing rod that is simple and inexpensive to manufacture.

ANOTHER OBJECT of the present invention is to provide a device for protecting a fishing rod that is simple to use on a fishing rod that is fully rigged with reel and tackle OR not rigged with reel and tackle.

ANOTHER OBJECT of the present invention is to provide ample viewing of the contents therein while applied.

ANOTHER OBJECT of the present invention is that it be convenient to store during non-use.

### BRIEF DESCRIPTION OF DRAWINGS

FIG. 1 is a pictorial representation of the invention not yet installed on a fishing rod

FIG. 2 is a pictorial representation of the invention with parts nesting together for convenient handling and storage during non-use

FIG. 3 is a variation of FIG. 1 depicting tapered shaped tubes rather than symmetrical cylindrical tubes.

FIG. 4 is a pictorial representation of the invention installed on a one-piece fishing rod while still rigged with reel, line, and lure.

FIG. 5 is a variation of FIG. 4 depicting the invention installed on a two-piece fishing rod while still rigged with reel, line, and lure.

### DETAILED DESCRIPTION OF DRAWINGS

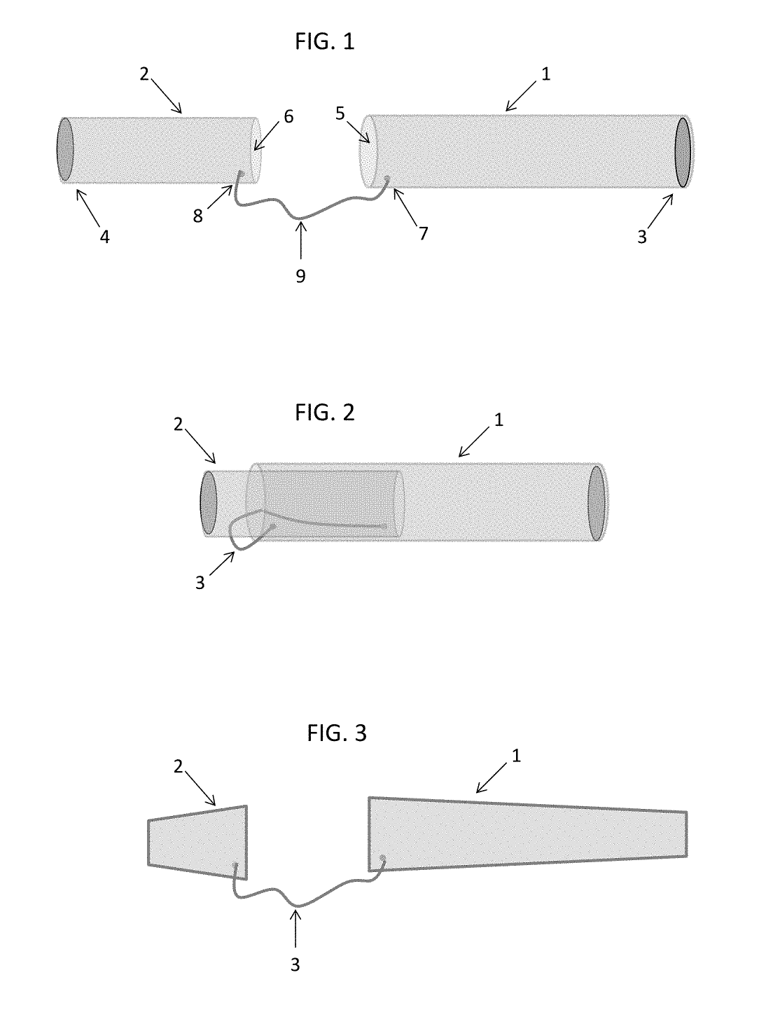

FIG. 1 is a pictorial representation of the invention not yet installed on a fishing rod. This invention is comprised of a first hollow tube (1) that is closed at one end (3) and open at the other end (5), and has a place (7) near the open end (3) such as a hole, tab, clip, or the like, to attach an elastic cord (9). There is also a second hollow tube (2) that is closed at one end (4) and open at the other end (6).), and has a place (8) near the open end (4) such as a hole, tab, clip, or the like, to attach an elastic cord (9). One end of the elastic cord (9) is attached to the first tube (1) at a place (7) near the open end (5) by means of tying, clipping, gluing, or the like. The other end of the elastic cord (9) is attached to the second tube (2) at a place (8) near the open end (6) by means of tying, clipping, gluing, or the like, thus creating a protective harness able to be used on a fishing rod.

Description of FIG. 1 by Numbers:
1. First hollow tube, closed at one end, open on the other end
2. Second hollow tube, closed at one end, open on the other end
3. Closed end of first hollow tube
4. Closed end of second hollow tube
5. Open end of first hollow tube
6. Open end of second hollow tube
7. Place to attach elastic cord to first hollow tube (via hole, tab, clip, or the like)
8. Place to attach elastic cord to second hollow tube (via hole, tab, clip, or the like)
9. Elastic cord, attached to both tubes thus creating a harness

FIG. 2 is a pictorial representation of the invention with parts nested together for convenient handling and storage during non-use. The second hollow tube (2) slides conveniently inside the first hollow tube (1) with the elastic cord (3) still attached to both tubes.

Description of FIG. 2 by Numbers:
1. First hollow tube nesting outside of the second hollow tube
2. Second hollow tube nesting inside of the first hollow tube
3. Elastic cord still attached to both tubes

FIG. 3 is a variation of FIG. 1 depicting tapered shaped tubes instead of symmetrical cylindrical tubes. The first hollow tapered shape tube (1) is connected to the second hollow tapered shaped tube (2) by an elastic cord (3), thus creating a protective harness that can be used on a fishing rod.

Description of FIG. 3 by Numbers:
1. First hollow tapered tube, closed at one end, open on the other end
2. Second hollow tapered tube, closed at one end, open on the other end
3. Elastic cord, attached to both tubes thus creating a harness

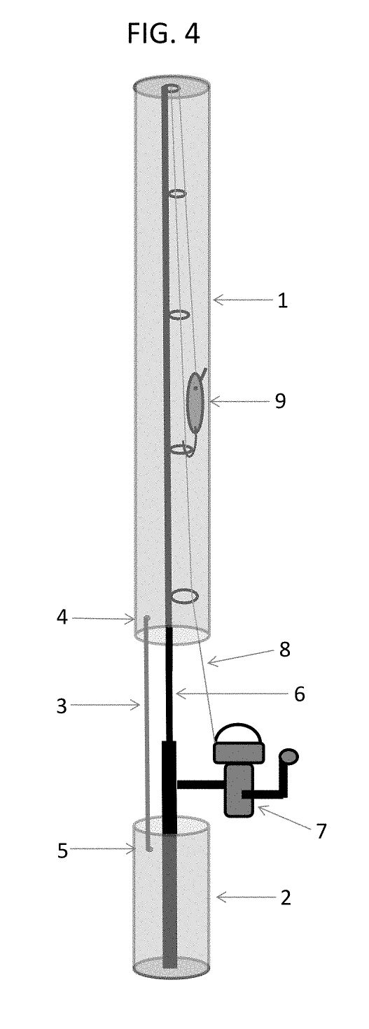

FIG. 4 is a pictorial representation of the invention installed on a one-piece fishing rod (6) while still rigged with reel (7), line (8), and lure (9). The first hollow tube (1) is encasing the upper portion of the fishing rod (6) with the tip of the rod resting against the closed end of the tube. The second hollow tube (2) is encasing the lower portion of the fishing rod (6) with the butt end of the handle resting against the closed end of the tube. An elastic cord (3) which connects the two tubes (4, 5) maintains tension to hold everything together, thus creating a protective harness and lure guard that adheres to the fishing rod.

Description of FIG. 4 by Numbers:
1. First hollow tube, closed at one end, open on the other end, with the open end slid over and covering the top (tip) portion of a one-piece fishing rod while still rigged with reel, line, and lure.
2. Second hollow tube, closed at one end, open on the other end, with the open end slid over and covering the bottom (handle) portion of a one-piece fishing rod.
3. Elastic cord, attached to both tubes and maintaining slight tension to hold everything together
4. Place to attach elastic cord to first hollow tube (hole, tab, clip, or the like)
5. Place to attach elastic cord to second hollow tube (hole, tab, clip, or the like)
6. Fishing Rod
7. Fishing reel
8. Fishing line strung through all the rod guides and tip
9. Fishing lure tied to the fishing line and hooked around a rod guide

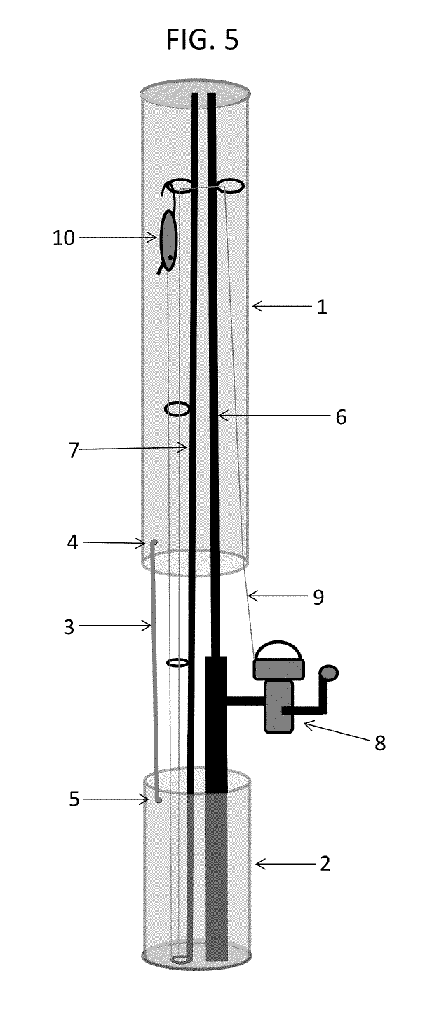

FIG. 5 is a variation of FIG. 4 depicting the invention installed on a two-piece fishing rod.

The rod is broken down into its two pieces (6, 7) and folded in half with the reel (8), line (9), and lure (10) still attached. The first hollow tube (1) is encasing the upper portion of the rod halves (6, 7)) with the ends of the rod halves resting against the closed end of the tube. The second hollow tube (2) is encasing the lower portion of the rod halves (6, 7) with the handle and rod tip resting against the closed end of the tube. An elastic cord (3) which connects the two tubes (1, 2) maintains tension to hold everything together, thus creating a protective harness and lure guard that adheres to the fishing rod.

Description of FIG. 5 by Numbers:
1. First hollow tube, closed at one end, open on the other end, with the open end slid over and covering both rod pieces of a two-piece rod while broken down in half yet still rigged with reel, line, and lure.
2. Second hollow tube, closed at one end, open on the other end, with the open end slid over and covering the bottom (handle) portion of a two-piece rod while broken down in half.
3. Elastic cord, attached to both tubes and maintaining slight tension to hold everything together
4. Place to attach elastic cord to first hollow tube (hole, tab, clip, or the like)
5. Place to attach elastic cord to second hollow tube (hole, tab, clip, or the like)
6. Bottom (handle) portion of 2-piece fishing rod
7. Top (tip) portion of 2-piece fishing rod
8. Fishing reel
9. Fishing line strung through all the rod guides and tip
10. Fishing lure tied to the fishing line and hooked around a rod guide

I claim:

1. An improved fishing rod protector and lure guard comprising; in combination:
a first hollow cylindrical or tapered tube capped/closed on one end and open on the other, a place (hole, tab, clip, or the like) near the open end of the tube to attach an elastic cord,
a second hollow cylindrical or tapered tube capped/closed on one end and open on the other, a place (hole, tab, clip, or the like) near the open end to attach an elastic cord,
an elastic cord that attaches near the open end of each hollow tube.

2. A diameter of the second hollow tube that is different from the diameter of the first hollow tube so that the two tubes may nest one inside the other for convenient handling and storage.
